(19) United States
(12) Patent Application Publication
(10) Pub. No.: US 2016/0182930 A1
(43) Pub. Date: Jun. 23, 2016

(54) SYSTEMS AND METHODS FOR ENABLING SIMULTANEOUS SECOND SCREEN DATA ACCESS DURING ONGOING PRIMARY SCREEN PROGRAMMING

(71) Applicants: Isabella V. Ortiz, Albuquerque, NM (US); Luis M. Ortiz, Albuquerque, NM (US)

(72) Inventors: Isabella V. Ortiz, Albuquerque, NM (US); Luis M. Ortiz, Albuquerque, NM (US)

(21) Appl. No.: 14/976,546

(22) Filed: Dec. 21, 2015

Related U.S. Application Data
(63) Continuation-in-part of application No. 14/337,516, filed on Jul. 22, 2014, now Pat. No. 9,282,364.
(60) Provisional application No. 61/877,842, filed on Sep. 13, 2013.

(51) Int. Cl. H04N 21/254; H04N 21/44; G06K 9/00; H04N 21/41; G11B 27/10; H04N 21/258; H04N 21/45; H04N 21/4627; H04N 21/845

(52) U.S. Cl. CPC H04N 21/2541; H04N 21/4627; H04N 21/44008; G06K 9/00758; H04N 21/8456; G11B 27/10; H04N 21/25866; H04N 21/4532; H04N 21/4122

(57) ABSTRACT

Handheld devices can be adapted to capture images of video programming being displayed on display screens integrated in a flat panel display using a digital camera integrated in the handheld devices, connect over a data network to a remote server wherein an image of the video programming can be compared with images of videos stored in a database associated with the remote server to locate matching video programming, receive notification of the availability matching video programming from the remote server, and access data including replayable video related to the video programming being displayed on the display screen based on the notification of the matching video programming availability. Remote servers can be configured to provide applications accessible by handheld devices for execution to conduct methods of a video programming recognition and access to data including replayable video associated with recognized video programming.

This application claims priority as a Continuation-In-Part application under 35 U.S.C. §119(e) of U.S. patent application Ser. No. 14/337,516, entitled “Systems and Methods for Enabling Simultaneous Second Screen Video Segment Replay During Ongoing Primary Screen Programming,” which was filed on Jul. 22, 2014, which claims the benefit of U.S. Provisional Patent Application Ser. No. 61/877,842, entitled “Systems and Methods for Enabling Simultaneous Second Screen Video Segment Replay During Ongoing Primary Screen Programming,” which was filed on Sep. 13, 2013, the disclosures of which are incorporated herein by reference in their entirety.

### FIELD OF THE INVENTION

The present invention is generally related to wireless handheld devices such as smartphones and also to flat panel displays such as smart TVs. The present invention is also related to the exchange of data between electronic devices. The present invention is also generally related to digital video recording systems. The present invention is also related to providing handheld device access to data including repayable video related to video programming being displayed on the flat panel display screen with access based on the identification of matching video programming availability at a remote server.

### BACKGROUND

Digital video can be recorded in and streamed from digital video recording devices (i.e., Digital Video recorders, or DVRs), which are typically provided in the form of a set-top box that is generally being used as a companion device with a large video display such as a flat panel television set commonly mounted to a wall or sitting on a table. DVRs are typically provided to cable and satellite television company customers so that the customers can access and record scheduled programming. Video can also be streamed from remote servers over wired and wireless data network connections via modules installed in flat panel television sets or as companion devices such as DVD players and small boxes such as Applet and Roku running applications provided by pre-recorded video service providers such as Apple, Netflix, and Vudu.

Systems are now being provided with applications that enable mobile devices such as smartphones and tablet computers to stream video content to a flat panel television set via a data rendering module (e.g., AppleTV, Roku). Apple Corporation refers to its application as AirPlay™. AirPlay™ enables a user to render video or other data content displayed on an iPhone on a secondary flat panel display screen connected to the AppleTV™ set-top box. U.S. Pat. No. 7,630,721 entitled “Systems, methods and apparatuses for brokering data between wireless devices and data rendering devices” issued to Ortiz also describes this capability.

Television sets today can be connected to data networks (e.g., the Internet) and are being marketed as “Smart TVs” because of their data network accessing capabilities, as well as the smartphone-like user interfaces they provide. Smart televisions and smartphones have only recently been able to interact with what is being referred to as “second screen” applications; however, applications that are currently available are limited to the wireless rendering of data that is either provided from a smartphone onto the screen of a flat panel display utilizing small gateway and video streaming devices such as those provided by Apple (e.g., Apple TV's Airplay) and Roku, or where data associated with programming displayed on the flat panel display is accessed by the second screen (e.g., smartphone) from a remote server (i.e., website) only after identifying a program being watched on a larger flat panel display to the server by name or access code.

Media sharing to flat panels directly from handhelds to flat panels has also been enabled using other wireless means or standards such as DLNA via a router, and directly with flat panel devices using WIFI direct, which has recently been accomplished with applications such as Multiscreen Play (by Hisense), AllJoyn and Snapdragon (by Qualcomm), Content Share (by Haier), Miracast (by Panasonic), SmartShare (by LG), and others. Yet all of these applications only teach sharing of data in one direction—from handheld devices (second screen) to larger flat panel devices (primary screen).

To date, flat panel displays (Smart TVs) are not known to be able to provide data directly to smartphones following a request to the flat panel initiated by the smartphone. All data delivery today appears limited to what is provided from a handheld device (smartphone, tablet, laptop) to a large data network-enabled flat panel display (Smart TV), typically by utilizing the screen/data sharing technologies. All current data exchange solutions include interaction between two devices, a smartphone and a flat panel display/smart TV that are already connected to each other and are wirelessly engaged to provide commands and data from the handheld device to the flat panel display or a smartphone and a remote server based on information obtained about a program being displayed on a flat panel display. There is currently no intermediary device or application that can identify information that is available for smartphone retrieval from memory based directly on what is being displayed on flat panel displays.

An interesting data access problem presents itself, for example, in a scenario where there are several screens displaying multimedia data to spectators located in a public venue (e.g., a sports bar, sports stadium, casino sports book), or even in a private den or office where multiple participants (spectators) are viewing a program. No solutions are currently available for spectators utilizing wireless handheld devices to access/select data associated with (or being rendered on) a screen, whether the screen is located in a private home or if chosen from several screens co-located at the venue where various multimedia content is being simultaneously displayed. The present inventors believe that spectators/observers at home or at a public venue would like the ability to access specific content being displayed on and/or otherwise interact with data based on what is being displayed on any primary screen. This is especially true with respect to sports programming where fans often desire to access data associated with programming that will enable them to see a streaming replay of past video and access related statistics.

The current inventors believe that the state of the art can be improved. Current systems do not enable a user of a mobile device (e.g., smartphone) that is serving as a second screen to retrieved segments of video of various lengths (e.g., 30 sec, 60 sec, 120 sec, 180 sec, 4 min, 5 min, 10 mins, etc.) from video content being displayed on a flat panel television set serving as a primary display without disturbing what is currently being displayed on the flat panel television set. Being able to accomplish this would be desirable when an observer of programming being displayed on the primary screen would like to replay past video from the ongoing programming without disturbing the flow of the programming when it is also being watched on the primary screen by other observers in a room.

An example for when such a need would present itself is when a person is absent during a critical play in a live sporting event being displayed on a primary flat panel television set being watched by several observers (e.g., sports fans at a sports bar). The missing person may have missed the critical play when going to the restroom, or otherwise leaving the venue temporarily. Upon returning to resume watching the live sporting event on the primary screen, he is informed by another observer that he “missed a fantastic play.” Usually, the person would simply miss out on seeing what happened. But, if a solution envisioned by the present inventors were available, then the person would be able to use their smartphone to identify video programming on the primary screen and retrieve data including video (e.g., a past video segment queued in a memory and representing the past programming recently shown on the primary screen) and display it on the smartphone without disturbing the associated live programming as it is being displayed on the primary screen for other observers that continue to observe.

There is certainly a need for such a system given the growing demand and appetite for technology that will enhance viewing of entertainment and sports content. There is also a need for new ways to generate advertising revenue while leveraging technology such as this, which will also be described herein.

### SUMMARY

It is therefore a feature of the embodiments to enable portable handheld device users to use the portable handheld device (e.g., smartphone, tablet) operating as a second screen to access data including replayable video (e.g., a video segment of past video for video programming being displayed on a flat panel television) from a remote server based on a match of an image captured by the handheld device camera of video programming being displayed on a flat panel television display operating as a primary screen with images of video programming stored in a remote server.

It is another feature for the data including replayable video to comprise video segments in variable duration of time that can be provided to handheld devices as replays of past video programming.

It is yet another feature for the a media module to be associated with the handheld device to enable capturing of an image of a live broadcast of video programming being displayed on a display screen utilizing a camera integrated in the handheld device, matching of the image captured by the camera with images of video programming stored in a remote server, and provide access to data including replayable video associated with the video programming based on a match with at least one image at the remote server.

It is yet another feature that the media module can be downloaded into the handheld device from an application server prior to use.

In accordance with yet another feature, an application (“APP”) that enables portable handheld device such as smartphones to interact with the media modules or flat panels by use of a software application that can be downloaded from application providers (e.g., Apple, Google Android, Amazon, etc.).

It is yet another feature that the capabilities of the invention can generally be referred to as simultaneous second screen video segment replay during ongoing primary screen programming. Data associated with the replayed video can also be included with the retrieval of replayable video, including audio, text, and advertisements.

In accordance with additional features, handheld device users can activate an application on their portable handheld device that can enable the user to discover a listing of available video segment replay modules associated with flat panel television displays of interest (which may be one if used at a home, or can be more when multiple screens in sports bar or casino sports book scenarios, or otherwise depending on deployment or venue) and that can allow wireless access by handheld devices to video segments of past video programming being displayed (or previously displayed and stored in a queue) on the flat panel television displays. The smartphone users can select the amount of time for the replayed video segment (e.g., a range of time options can be present to include the past 30 seconds, or up to the past ten minutes or more) from the screen of interest or video segment replay module associated with the screen of interest.

In accordance with additional features, possible venues that can enable the video retrieval concepts disclosed herein from an application provided to handheld device user and/or a media module incorporated in or coupled to flat panel television displays that are located in: homes, lobbies, sports bars, sports venues, educational institutions, casino sports books, shopping centers, amusement parks, and the like.

Wireless standards that can be used to implement the invention include Bluetooth and WiFi direct, and can include other standards that may arise for transmitting video data between handheld devices and modules storing video data.

Smartphones, tablets, and laptops including a digital camera and wireless communication integrated therein can also be used to access data under the teaching described herein.

It is another feature that advertising can also be provided together with video segments retrieved from a remote server, for display before, during or after the video segment replay is rendered on portable the handheld device.

It is another feature that a method be provided to enable handheld device access to data including replayable video associated with video programming being displayed on flat panel displays located within at least wireless local area network range of the handheld devices, and that the method can include the steps of capturing an image of video programming being displayed on a display screen integrated in a flat panel display, wirelessly connecting with a remote server via a data network, comparing the image of the video programming with images of videos stored in a database in the remote server to locate matching video programming, identifying availability of the matching video programming to the handheld device, and providing the handheld device with access to data including replayable video related to the video programming being displayed on the display screen based on an indication of the matching video programming availability.

It is yet another feature that media can be retrieved based on a user profile and preferences. User profile information can also include pre-registered account information for purposes of selected a server to access data. The user may already be registered with a particular service (e.g., a paid cable, satellite or subscription media account) from which the user prefers to retrieve content related to the match, if such media is available via servers associated with the preregistered account.

### BRIEF DESCRIPTION OF THE FIGURES

FIG. 1 illustrates a system enabling discovery of and access to data including video associated with programming displayed on a flat panel via a handheld device and data selected by a handheld device, wherein a video segment replay module can include hardware or software, be standalone or attached to a flat panel display, be integrated within the flat panel, or be provided as downloadable software stored and operating on a handheld device an adapted to access as data including replay video from the cloud (e.g., from a remote server over a data network);

FIG. 2 illustrates a system enabling capturing of an image of video programming rendering on a select display screen with a camera integrated in a handheld device, and providing access to a remote server to compare the captured image with images of video programming and enabling access to data including replayable video when matching video programming is identified. The data including replay video can be obtained as past video in recorded time from a remote server and/or via a recorded video module integrated in or attached to the flat panel display. The remote server can be accessible over a data network (e.g., from the cloud) after discovery of the desired flat panel display. Also illustrated without limitation is a screen shot on the handheld device the identified (e.g., matched) content and a list of replay time period options for retrieval of recorded video segments as part of the accessible data.

FIG. 3 illustrates a screen shot from a handheld device illustrating a video content accessed as a video segment replay being displayed on the handheld device;

FIG. 4 illustrates a block diagram of steps for video programming rendering on a flat panel display with a handheld device and accessing data associated with video programming displayed on the flat panel for replayable video on the handheld device; and

FIG. 5 illustrates a block diagram of steps enabling identification of video programming rendering on a flat panel device by handheld devices and for providing the handheld devices with access to data included replayable video associated with video programming displayed on the flat panel.

### DETAILED DESCRIPTION OF THE INVENTION

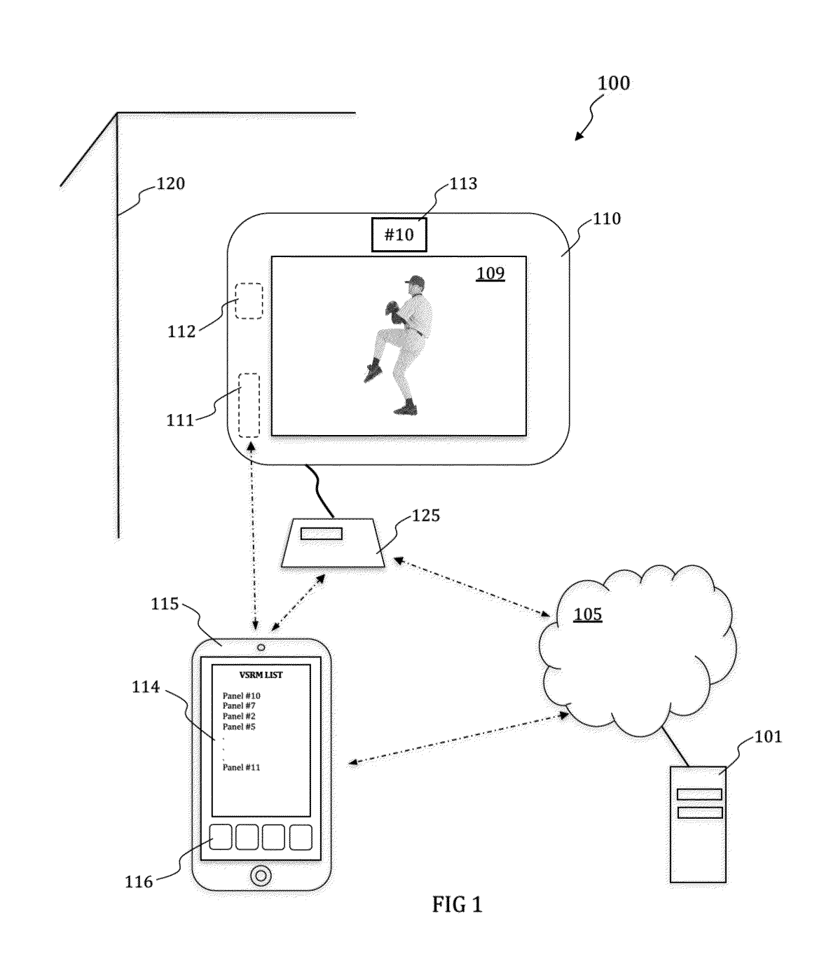

FIG. 1. Illustrates a system 100 enabling recorded video module and/or flat panel discovery and access to recorded video data associated with programming displayed on a flat panel 110 selected by a handheld device 115. Handheld device 115 can be provided in the form of a smartphone, tablet computer, or other portable computing devices that include an integrated digital camera, display screen and wireless data access. A flat panel 110 can also have access to a data network 105 to retrieve programming and information from a remote server 101. The flat panel 110 can also have an internal wireless communication module 111 (e.g., WiFi or Bluetooth, or both) to support communications with nearby handheld devices 115 or to obtain further data access from the network 105. The flat panel device can include a memory 112 that can function as a queue to store programming displayed on a display screen (e.g., LCD, LED, Plasma, or the like) integrated in the flat panel, and which can include a limited amount of past programming previously displayed on the display screen 109 integrated in the flat panel.

The wireless communication module can wirelessly broadcast identifying information 113 for the flat panel 110 to nearby handheld devices 115. The identifying information can be, for example, an identification number 113 (e.g., label, location or type of flat panel), or it can be a specific location in a venue/home. When multiple flat panels exists, identifying information 113 can be physically located on or near a flat panel 110 so that it can easily be read by spectators, or it can be provided as electronic information broadcasted about the physical location of the flat panel 110 in a venue 120, and broadcasted information about programming being displayed on the flat panel 110. The broadcast of wireless-enabled device identities is common for WiFi hotspots and Bluetooth connected devices, where identifying information is periodically sent for receipt by devices in search of a wireless data connection; however, flat panel television sets do not broadcast identifying information (in particular, after market labels, or physical location information), and information broadcasted from other devices today are not used for purposes of obtaining data including replay video associated with video programming displayed on flat panel displays where numerous other flat panel displays may also be co-located (located next to each other) in a crowded venue (e.g., a sports bar, casino or sports stadium).

Flat panels 110 enabled with a wireless communication module 111 can be programmed with embedded or downloadable software to operate as a video segment replay module and wirelessly broadcast identifying information rather than just the manufacturer and model information. Manufacturer and model information would be useless if broadcasted from ten flat panel devices in a sports bar that are made by the same manufacturer and are the same model. This is why the use of unique identifying information in accordance with some features of the present invention can be useful. Information will be described in further detail below, but can include physical location, programming information or a name/label physically attached to the flat panel to assist users in identification of data associated with the media rendering on the desired flat panel to interact with.

The video segment replay module functionality can be provided with a combination of hardware and software resident in either a flat panel display or a set top box. A set top box 125 is shown connected to a flat panel display in FIG. 1. Software can be downloaded as an application (or APP) from a remote server for operation on the flat panel display 110 or set top box 125. The set top box, like the flat panel display, can be connected to the Internet and remote servers for programming content and to retrieve data and applications.

The handheld device 115 can be provided in the form of a smartphone (e.g., iPhone, Android-based smartphone) and include an application 116 (an APP) that enables integration with video segment replay modules and enables the discovery of available video segment replay modules associated with flat panels 110 or set top boxes 125 located near the handheld device 115. Discovery of video segment replay modules can be accomplished by receiving identifying information 113 for the flat panel in a list of available devices 114. The flat panel 110 or set top box 125 associated with a flat panel 110 can be selected on the handheld device 115, and the handheld device 115 can then begin receiving data associated with programming displayed at the flat panel 110. The handheld device 115 can also interact with programming displayed at the flat panel 110 via the application 116.

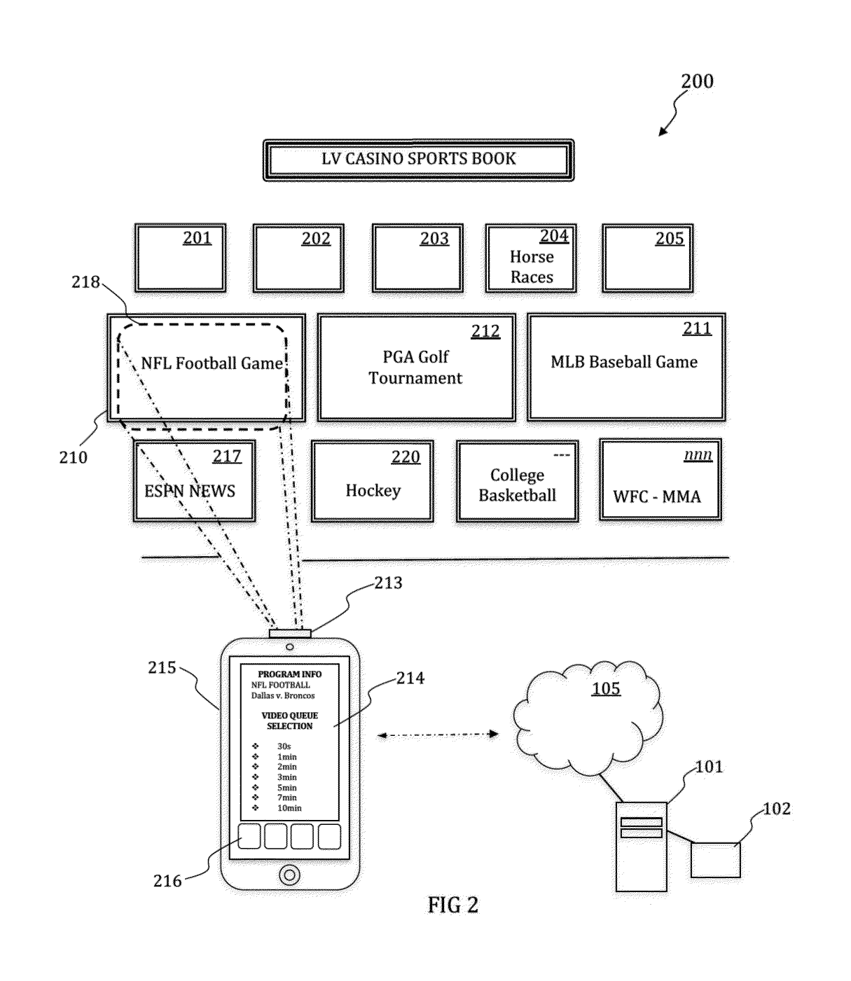

FIG. 2 illustrates a system 200 enabling identification of video programming rendering on a selected flat panel 210 in accordance with alternative features of the present invention. The system can enable handheld device 215 access to data including replayable video related to the video programming from a remote server based on the identification of video programming rendering on the selected flat panel 210. Accordingly, an image of the video programming (e.g., image of a live NFL Football Game) can be captured by a camera 213 integrated in the handheld device 215. The image can then be transferred to a remote server 101 accessible by the handheld device over a data network (e.g., via WIFI or cellular data) wherein the image can be compared to images of video programming, which can be stored in a database 102 associated with or accessible by the remote server 101. If the image matches the images of video programming stored in the database, a notification message and/or indication of the availability of data including replayable video associated with the video programming captured from the selected flat panel 210 is sent to the handheld device 215. The handheld device can capture the image from the selected flat panel 210 with the handheld device 215 despite the availability of several additional flat panel devices 201, 202, 212, and 217, in close proximity to selected flat panel 210 because only the image from the selected flat panel 210 is what is used for comparison at the server and for an indication of related data and video programming availability. As shown on the display screen 214 of handheld device 215, the programming can be identified (e.g., “NFL-Football Dallas v. Broncos”) once a match is determined. Available data can include a replayable video segment (e.g., 20 s, 1 min, 3 min, etc.) as also shown on display screen 214. Obviously, more or less time can be retrieved, or a user can be given a choice to enter the amount of time on a keypad associated with the touchscreen on the handheld device 215. The data can be managed with the touchscreen user interface of the handheld device 215, which is typically feature of modern smartphones and tablet computers together with wireless data network access and an integrated camera.

The ability to single out a specific flat panel and access replayable video data based on media rendering on the selected flat panel is an important features of the invention: in settings where numerous screens might be present. Such a scenario would be common in a publicly accessible venue, such as a sports bar, sports venue, lobby or casino sports book where multiple flat panel displays rendering various programming are available. In this type of scenario, a software application can be opened on the handheld device 215 that will enable the handheld device 215 to capture images, compare images and identify matching video images for video programming being displayed on a select flat panel 210, and then obtain access to replayable video data that is associated with the matched video images and video programming. A user of the handheld device can then choose to capture an image from another flat panel device (e.g., flat panel 211, “MLB Baseball Game”) if the user desires access to new data including replayable video related to a different video program.

Also shown on the screenshot 214 is a choice of the amount of time a user wants to review (replay) video retrieved from the memory/queue/server. The examples shown, without limiting the scope of the invention, are thirty seconds, 1 minute, 2 minutes, 3 minutes, 5 minutes, 7 minutes, and 10 minutes.

In accordance with features, a system deployed in a sports stadium can enable sports fans using smartphones to interact with media being displayed at the venue to retrieve past video, instant replays, statistics, and other data based on programming being viewed on numerous flat panel displays typically located within such a venue. A football fan, for example, can re-watch an instant replay, or replayable video, for a video programming he just viewed on a flat panel display located near his seat, a baseball fan can review additional facts statistics for an athlete shown on a flat panel that is currently at bat. The invention benefits all sports (basketball, soccer, ice hockey, tennis) so long as flat panel displays exist in the venue with the present invention capabilities and are displaying active programming to attendees. Programming information can be used by the handheld device to retrieve additional information from a remote server as previously described.

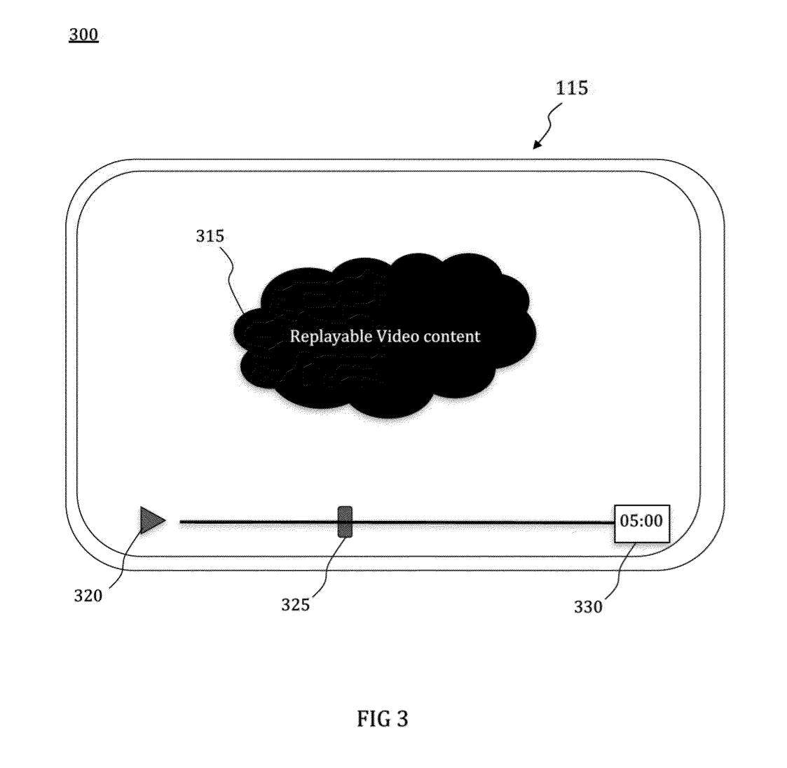

FIG. 3 illustrates a screen shot 300 from a handheld device 115 illustrating a video content 315 accessed via a video segment replay module being displayed on the handheld device 115. As taught herein, a handheld device user can select a flat panel from a list or from a captured image based on the handheld device user's programming of interest that is being shown on a flat panel. Once selected, the handheld device 115 will be engaged in a data retrieval and/or interaction session. Data can be retrieved based on real-time (or near real-time, accounting for network delays) programming that is being displayed on a display associated with the handheld device after being accessed/downloaded from a memory associated with any of a server, a media module associated with a selected flat panel, or a video segment replay module, that can be selected and data retrieved by the handheld device. This aspect of the invention is of high value in sports media where fast moving games can cause a sports fan to miss an important play or statistical information about an athlete or team that has already passed the screen. A user can be provided with limited access to past programming streaming from a queue/memory associated with a server or the flat panel device, however, a menu of past programming as described with respect to FIG. 3 will simplify access to desired information by users. The listing can be provided in the form of time (e.g., “rewind 30 seconds”, “rewind 1 minute”, “rewind 2 minutes”) or based on identifying information (e.g., “last commercial”, “2^{nd}-last commercial”, “3^{rd} last commercial”). Alternatively, the content can be displayed as recorded video with a scroll bar that can include “pause”, “play”, “forward”, and “rewind” capabilities, similar to that provided for reviewing YouTube videos. FIG. 3 illustrates a play button 320, a scroll bar button 325 to enable a user to move back and forth within a video, and a time counter 330 showing how much longer a video is or how much time is left to review. The display of stored video content previously displayed by the flat panel and stored in the queue can also be enhanced with image tiles that pop up as the user moves along the scroll bar to help the user focus in on images for the video location that the user wants to review from the queue. Once the proper content is identified, the user can access data associated with the past programming/content and replay past video at selected segments of time.

Access to data from remote servers can also depend on location of the handheld device 215, based on any of GPS or network access (e.g., IP router Address, cell tower identification, signal triangulation), Location can enable the location servers in closer proximity to handheld device 215 in order to help reduce network delay and improve video data streaming quality. Alternate servers can also be purposely selected by a user or be based on a user profile (e.g., a profile set up in the App or registered in a user account or device) because of language requirements (e.g., the need for audio and text in Spanish or French, instead of English). User profile information can also include pre-registered account information for purposes of selected a server to access data. The user may already be registered with a particular service (e.g., a paid cable, satellite or subscription media account) from which the user prefers to retrieve content related to the match, if such media is available via servers associated with the preregistered account.

An application can enable the scanning of video programming rendering on the flat panel by the handheld device 215 by assuring that the camera 213 captures an entire screen of the flat panel within a scan window displayed on the handheld device display. This can assure media match accuracy. Additionally, scan quality can be enhanced at closer distances to a video monitor screen and by preventing large angles with respect to the mobile devices location in front of the video monitor. Notice that the handheld device 215 in FIG. 2 is slightly offset to the right of flat panel 210, which could affect capture quality and can be corrected by moving slightly to the left for a straight-on image capture.

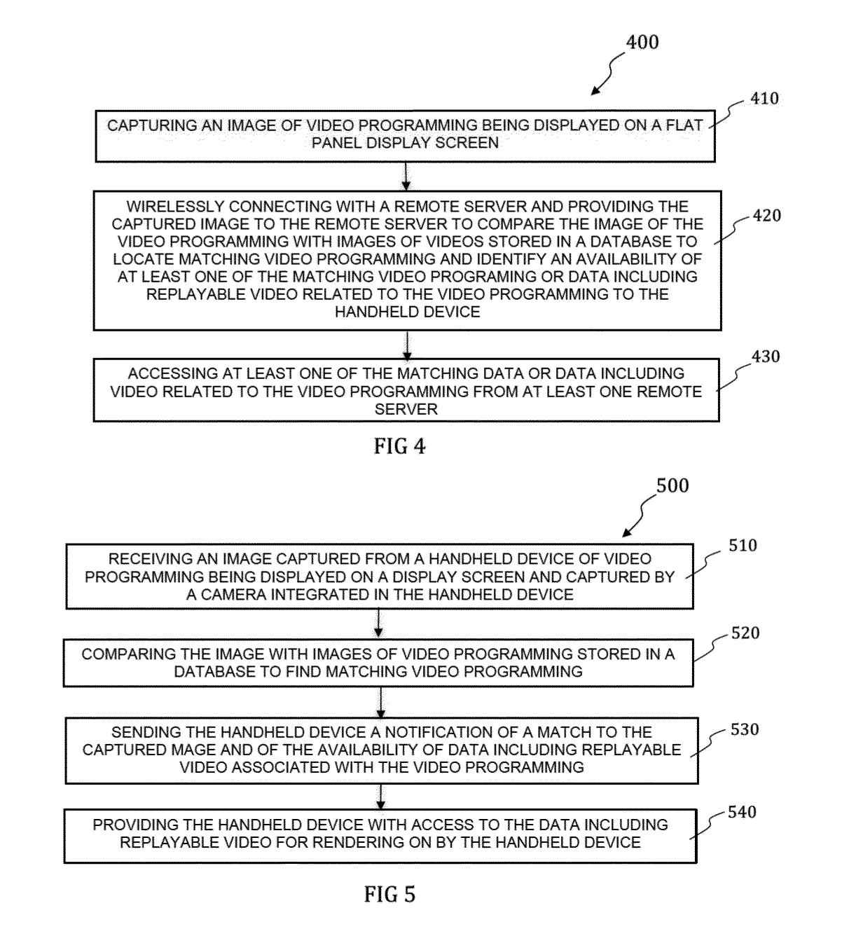

FIG. 4 illustrates a block diagram 400 of steps for enabling handheld device access to data including replayable video associated with video programming being displayed on flat panel displays located within at least wireless local area network range of the handheld devices. As shown in block 410, a handheld device can capture an image of video programming being displayed on a display screen of a flat panel display. In block 420, the handheld device connects with a remote server via a data network and provides the captured image to the remote server where the remote server compares the image of the video programming with images of videos stored in a database in the remote server to locate matching video programming and identify an availability of the matching video programming or data including replayable video related to the video programming to the handheld device. Then as shown in Block 430, the handheld device obtains access to at least one of the matching data or data including replayable video related to the video programming from at least one remote server. The reason at least one remote server is indicated is because the system or server may locate servers other than the original server contacted to analyze the captured image that are in closer proximity to the handheld device, thereby enhancing video streaming quality and reducing delay.

FIG. 5 illustrates a block diagram 500 of steps of using a remote server to assist a handheld device that has captured an image of video programming of interest rendering on a flat panel display to access data including video related to the video programming being displayed on the flat panel display based on the capture image. As shown in block 510, a remote server receives an image from a registered handheld device of video programming being display on a display screen and captured by a camera integrated in the registered handheld device. The handheld device then wirelessly discovers broadcasts of identification information from the flat panel displays as shown in block 520. The handheld device is then used to select a flat panel display and obtains information associated with programming being displayed on the flat panel as shown in block 530. The information can include data (e.g., video, replay, etc.), but the handheld device can use information obtained from the flat panel to then access additional data associated with the programming being displaying on the selected flat panel display as shown in block 540.

It should be appreciated that handheld devices can be pre-registered and/or pre-authorized to access the remote server or servers to employ the services taught herein. Registration can require any of: user identity, contact/address information, demographics, setting up a username, setting up a password, occupation, areas of interest, and payment of a fee. Registered user can then be recognized by a server based on device identification or upon logging into the server.

It should also be appreciated that advertising data (e.g., in the form of text ads or short video commercials) can be provided to handheld devices obtaining data including video that is of interest (related to the video programming displayed on a flat panel) prior to, or after, receiving the data including video. Advertising data can support a revenue model for a service embodying the features of the present invention so that the service can be provided free of charge to end users rather than collecting user fees.

It should be appreciated from the foregoing disclosure that the methods and systems described herein can be utilized in various environments including private offices or living rooms and public venues such as sports bars, casinos, sports stadiums, shopping centers, amusement parks, transportation terminals, educational institutions, and others public and private locations.

1. A method enabling handheld device access to data including video associated with video programming being displayed on flat panel displays located within at least wireless local area network range of the handheld devices, comprising:
capturing an image of video programming being displayed on a display screen integrated in a flat panel display;
wirelessly connecting with a remote server via a data network and providing the captured image to the remote server to compare the image of the video programming with images of videos stored in a database to locate matching video programming and identify an availability of at least one of matching video programming or data including replayable video related to the matching video programming to the handheld device; and
accessing at least one of the matching video or the data including replayable video related to the video programming from at least one remote server.

2. The method of claim 1, wherein the data including replayable video includes at least one recorded segment of past video data associated with the video programming.

3. The method of claim 1, wherein the data including replayable video is stored in and accessible from the remote server.

4. The method of claim 1, wherein the data including replayable video associated with the at least one recorded segment is stored in and accessible from at least one remote server in addition to the remove server.

5. The server of claim 2, wherein the data including replayable video associated with the at least one recorded segment is also stored in and accessible from at least one remote based on at least one of user location or user profile information.

6. The server of claim 2, wherein said at least one recorded segment of the past video is rendered on the handheld device with a selectable time interval of between thirty seconds to ten minutes for review on the at least one handheld device as the video programming is simultaneously being displayed on the display screen without interruption of the video programming as the video programming is being simultaneously displayed on the selected flat panel display.

7. A method enabling handheld device access data including replayable video associated with video programming rendering on flat panel displays located within wireless local area network range of the handheld device, comprising:
activating an application on a handheld device to enable: capturing of an image of video programming being displayed on a display screen utilizing a camera integrated in the handheld device, matching of the image captured by the camera with images of video programming stored in a remote server, and access to data including replayable video associated with the video programming based on a match with at least one image at the remote server;
capturing an image of video programming being displayed on a display screen integrated in a flat panel display;
wirelessly connecting the handheld device with a remote server via a data network wherein the image of the video programming is compared with images of videos stored in a database in the remote server to locate matching video programming;
receiving notification of matching video programming availability and data including repayable video associated with the video programming from at least one remote server at the handheld device; and
accessing data including replayable video related to the video programming from the at least one remote server.

8. The method of claim 7, wherein the data including replay video includes at least one recorded segment of past video data associated with the video programming.

9. The method of claim 7, wherein the data including replayable video is stored in and accessible from the remote server.

10. The server of claim 8, wherein the data including replayable video associated with the at least one recorded segment is also stored in and accessible from at least one remote server in addition to the remove server.

11. The server of claim 8, wherein said at least one recorded segment of the past video is rendered on the handheld device with a selectable time interval of between thirty seconds to ten minutes for review on the at least one handheld device as the video programming is simultaneously being displayed on the display screen without interruption of the video programming as the video programming is being simultaneously displayed on the selected flat panel display.

12. A server comprising applications accessible by handheld devices for execution to conduct methods of a video programming recognition and access to data including replayable video associated with recognized video programming, comprising:
receiving an image captured from a handheld device of video programming being displayed on a display screen and captured by a camera integrated in the handheld device;
comparing the image with images of video programming stored in a database to find matching video programming;
sending the handheld device a notification of a match to the image and of the availability of data including replayable video associated with the video programming; and
providing the handheld device with access to the data including replayable video for rendering on by the handheld device.

13. The server of claim 12, wherein the data including replayable video include at least one recorded segment of past video data associated with the video programming.

14. The server of claim 12, wherein the data including replayable video is stored in and accessible from the remote server by the handheld device.

15. The server of claim 13, wherein the data including replayable video associated with the recorded segments is also stored in and accessible from at least one remote server in addition to the remove server and is accessible by the handheld device.

16. The server of claim 13, wherein: said at least one recorded segment of the past video is rendered on the handheld device with a selectable time interval of between thirty seconds to ten minutes for review on the at least one handheld device as the video programming is simultaneously being displayed on the display screen without interruption of the video programming as the video programming is being simultaneously displayed on the selected flat panel display.

17. The server of claim 12, wherein the data including replayable video is stored in and accessible from the remote server by the handheld device if the handheld device is registered and authorized to access data by the remote server.

18. The server of claim 12, wherein the data including replayable video associated with the recorded segments is also stored in and accessible from at least one remote server in addition to the remove server and is accessible by the handheld device if the handheld device is registered and authorized to access data by the remote server.
